(19) United States
(12) Patent Application Publication
(10) Pub. No.: US 2011/0018426 A1
(43) Pub. Date: Jan. 27, 2011

(54) FLUOROPHORES AND MANUFACTURING METHOD THEREOF

(75) Inventors: Kenji Toda, Niigata-shi (JP); Kazuyoshi Uematsu, Niigata-shi (JP); Mineo Sato, Niigata-shi (JP); Tetsu Umeda, Ushiku-shi (JP); Yutaka Ito, Tsukuba (JP)

Correspondence Address: SUGHRUE MION, PLLC, 2100 PENNSYLVANIA AVENUE, N.W., SUITE 800, WASHINGTON, DC, 20037, US

(73) Assignees: NIGATA UNIVERSITY, Niigata-shi, Niigata (JP); SUMITOMO CHEMICAL COMPANY, LIMITED, Chuo-ku, Tokyo (JP)

(21) Appl. No.: 12/933,335

(22) PCT Filed: Mar. 18, 2009
(86) PCT No.: PCT/JP2009/055268

§ 371 Date: Sep. 17, 2010

(30) Foreign Application Priority Data
Mar. 19, 2008 (JP) 2008-071109

(51) Int. Cl. H01J 1/62; C09K 11/77

(52) U.S. Cl. 313/483; 252/301.4 R

(57) ABSTRACT

Provided are phosphors that can provide emission devices that can further improve emission characteristics, principally, color rendering. Disclosed are phosphors made by substituting at least a portion of M² in compounds represented by Formula (1) with M⁴ (M⁴ represents a trivalent cationic element), substituting a portion of O in said compound with M⁵ (M⁵ represents a trivalent anionic element) and substituting a portion of M¹ and/or M² in said compound with an activated element. In Formula (1): aM¹O.3M²O.6M³O₂ (In Formula (1), M¹ represents one or more alkaline-earth elements selected from a group comprising Ba, Sr and Ca, M² represents one or more divalent metal elements selected from a group comprising Mg and Zn, M³ represents a tetravalent metal element and a is a value in the range 3 to 9.)

### TECHNICAL FIELD

The present invention relates to phosphors and a method of producing the same.

### BACKGROUND ART

A phosphor is used in a light-emitting device such as a white LED. The white LED is a light-emitting device emitting white light, which has a light-emitting element and a phosphor emitting light by being excited by at least part of the light emitted by the light-emitting element.

Light-emitting elements used in the white LED include a light-emitting element emitting blue light (hereinafter sometimes referred to as a blue LED) and a light-emitting element emitting near-ultraviolet to blue-violet light (hereinafter sometimes referred to as a near-ultraviolet LED).

PATENT DOCUMENT 1 discloses a phosphor represented by a formula (Ba, Eu)₉Sc₂Si₆O₂₄ as a phosphor emitting light by being excited by the light emitted by these light-emitting elements.

### PATENT DOCUMENT 1: JP 2007-77307 A (EXAMPLES)

### DISCLOSURE OF THE INVENTION

### Problems to be Solved by the Invention

The phosphor represented by the above formula is useful in the sense that the phosphor can provide a light-emitting device having excellent color rendering properties, for example, in combination with a Y₃Al₅O₁₂: Ce phosphor capable of emitting yellow light, particularly because the phosphor represented by the above formula emits green light. However, the improvement thereof has been still needed.

An object of the present invention is to provide a phosphor capable of providing a light-emitting device which can be further improved in light-emitting characteristics consisting mainly of color rendering properties compared to conventional light-emitting devices.

### Means for Solving the Problems

As a result of intensive studies, the present inventors have accomplished the present invention.

Thus, the present invention provides the following invention:

<1> A phosphor comprising a compound represented by a formula (1):

aM¹O.3M²O.6M³O₂ (1)

(wherein M¹ represents one or more alkaline earth metal elements selected from the group consisting of Ba, Sr, and Ca; M² represents one or more divalent metal elements selected from the group consisting of Mg and Zn; M³ represents a tetravalent metal element; and a represents a value in the range of 3 or more to 9 or less),

at least part of M² in the compound being substituted with M⁴ (wherein M⁴ represents a trivalent cation element),

part of O in the compound being substituted with M⁵ (wherein M⁵ represents a trivalent anion element), and

part of M¹ and/or M² in the compound being substituted with an activating element.

<2> The phosphor according to the above item <1>, wherein the value of a is 9.
<3> A phosphor comprising a compound represented by a formula (2):

M¹₉(M²_{3-1.5x}M⁴ₓ)M³₆O_{24-1.5y}M⁵_{y} (2)

(wherein each of M¹, M², M³, M⁴, and M⁵ has the same meaning as described above; x represents a value in the range of more than 0 to 2 or less; and y represents a value in the range of more than 0 to 2 or less),

part of M¹ and/or M² being substituted with an activating element.

<4> The phosphor according to the above item <2> or <3>, having the same type of crystal structure as that of merwinite.
<5> The phosphor according to any one of the above items <1> to <4>, wherein M³ is Si.
<6> The phosphor according to any one of the above items <1> to <5>, wherein M⁴ is Sc.
<7> The phosphor according to any one of the above items <1> to <6>, wherein M⁵ is N.
<8> The phosphor according to any one of the above items <1> to <7>, wherein part of M¹ in the compound is substituted with an activating element.
<9> The phosphor according to any one of the above items <1> to <8>, wherein the activating element is Eu.
<10> A method of producing a phosphor, comprising the steps of: firing a mixed raw material containing predetermined amounts of M¹, M³, M⁴, an activating element, and, if necessary, M² (wherein each of M¹, M², M³, and M⁴ has the same meaning as described above) in an oxygen-containing atmosphere; and further firing a residue in an M⁵-containing atmosphere (wherein M⁵ has the same meaning as described above).
<11> The method according to the above item <10>, wherein the M⁵-containing atmosphere is an ammonia-containing atmosphere.
<12> A light-emitting device comprising the phosphor according to any one of the above items <1> to <9>.
<13> A light-emitting device comprising a light-emitting element and a fluorescent material emitting light by being excited by at least part of the light emitted by the light-emitting element, wherein the fluorescent material comprises the phosphor according to any one of the above items <1> to <9>.
<14> The light-emitting device according to the above item <13>, wherein the light emitted by the light-emitting element is light having the miximum luminescence intensity wavelength (λmax) in the range of 350 nm or more to 480 nm or less, in a wavelength-luminescence intensity curve within the wavelength range of 300 nm or more to 780 nm or less.

### ADVANTAGES OF THE INVENTION

According to the present invention, a phosphor capable of providing a light-emitting device can be provided which can be further improved in light-emitting characteristics consisting mainly of color rendering properties. The present invention is suitable for light-emitting devices such as a white LED, i.e. light-emitting devices in which an excitation source for the phosphor is light emitted by a blue LED or an ultraviolet LED, and further can be applied to electron beam excited light-emitting devices in which an excitation source for the phosphor is an electron beam (e.g. a CRT, a field emission display, and a surface-conduction electron-emitter display), ultraviolet excited light-emitting devices in each of which an excitation source for the phosphor is ultraviolet light (e.g. a backlight for liquid crystal display, a 3-wavelength type fluorescent lamp, and a high load fluorescent lamp), vacuum ultraviolet excited light-emitting devices in which an excitation source for the phosphor is vacuum ultraviolet light (e.g. a plasma display panel and a rare gas lamp), light-emitting devices in which an excitation source for the phosphor is an X-ray (an X-ray imaging device and the like), and the like. Thus, the present invention is extremely industrially useful.

### BRIEF DESCRIPTION OF THE DRAWING

FIG. 1 shows a powder X-ray diffraction pattern of phosphor 2 in Example 1.

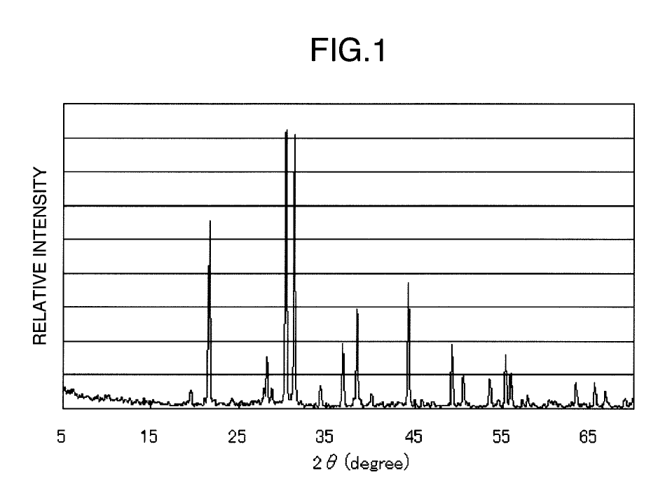

### BEST MODE FOR CARRYING OUT THE INVENTION

The present invention will be described below in detail.

The phosphor of the present invention is characterized by a compound represented by the following formula (1):

aM¹O.3M²O.6M³O₂ (1)

(wherein M¹ represents one or more alkaline earth metal elements selected from the group consisting of Ba, Sr, and Ca; M² represents one or more divalent metal elements selected from the group consisting of Mg and Zn; M³ represents a tetravalent metal element; and a represents a value in the range of 3 or more to 9 or less),

at least part of M² in the compound being substituted with M⁴ (wherein M⁴ represents a trivalent cation element),

with M⁴ (wherein M⁴ represents a trivalent cation element), substituting part of O in the compound being substituted with M⁵ (wherein M⁵ represents a trivalent anion element), with M⁵ (wherein M⁵ represents a trivalent anion element), and

substituting part of M¹ and/or M² in the compound with an activating element being substituted with an activating element.

In the above description, the crystal structure of the phosphor when the value of a is 3 may be the same type of crystal structure as that of diopside; the crystal structure of the phosphor when the value of a is 6 may be the same type of crystal structure as that of akermanite; and the crystal structure of the phosphor when the value of a is 9 may be the same type of crystal structure as that of merwinite. Among these, the value of a is preferably 9 in view of further increasing the effect of the present invention. These crystal structures can be identified by powder X-ray diffraction measurement.

The phosphor of the present invention when the value of a is 9 may be a phosphor comprising a compound represented by a formula (2):

M¹₉(M²_{3-1.5x}M⁴ₓ)M³₆O_{24-1.5y}M⁵_{y} (2)

(wherein each of M¹, M², M³, M⁴, and M⁵ has the same meaning as described above; x represents a value in the range of more than 0 to 2 or less; and y represents a value in the range of more than 0 to 2 or less),

part of M¹ and/or M² being substituted with an activating element, which is a preferable embodiment. This phosphor preferably further has the same type of crystal structure as that of merwinite.

According to the present invention, M¹ preferably contains at least Ba in view of light emission luminance and temperature characteristics of the phosphor; M¹ may be, for example, Ba.

According to the present invention, M² preferably at least contains Mg in view of increasing the crystallinity of the phosphor; M² may be, for example, Mg.

According to the present invention, the tetravalent metal element of M³ may be one or more elements selected from the group consisting of Si, Ti, Ge, Zr, Sn, and Hf M³ preferably contains at least Si in view of ease of handling; M³ may be, for example, Si.

According to the present invention, the trivalent cation element of M⁴ may be one or more elements selected from the group consisting of Al, Sc, Ga, Y, In, La, Gd, and Lu. M⁴ preferably contains at least Sc in view of increasing the crystallinity of the phosphor; M⁴ may be, for example, Sc.

According to the present invention, the trivalent anion element of M⁵ may be N.

The activating element which is used in the present invention may be properly selected from among rare earth elements and Mn. In the sense of increasing light emission luminance, the activating element is preferably Eu. When the activating element is Eu, part of Eu may be substituted with a coactivator element to further increase the light emission luminance. Examples of the coactivator element can include one or more elements selected from the group consisting of Al, Sc, Y, La, Gd, Ce, Pr, Nd, Pm, Sm, Tb, Dy, Ho, Er, Tm, Yb, Lu, Bi, Au, Ag, Cu, and Mn. The percentage of substitution may be 50 mol % or less based on Eu. The activating element preferably substitutes for part of M¹ in the above formula (1) or (2).

In the present invention, x is a value ranging from more than 0 to 2 or less. The valve of x can be adjusted in this range to provide the emission of light having any wavelength. More specifically, in the range of more than 0 to 2 or less, x can be made larger to provide the emission of light having a longer wavelength and x can be made smaller to provide the emission of light having a shorter wavelength. The value of y is a value ranging from more than 0 to 2 or less. The value of y can be adjusted in this range to provide the emission of light having any wavelength. More specifically, in the range of more than 0 to 2 or less, y can be made larger to provide the emission of light having a longer wavelength, and y can be made smaller to provide the emission of light having a shorter wavelength. In the sense of keeping a stable crystal structure, the relation of “x=y” is preferable.

The method of producing the phosphor of the present invention will now be described. The phosphor of the present invention can be produced by firing a mixed raw material having a composition capable of providing the phosphor of the present invention by firing. For example, it can be produced by firing a mixed raw material containing predetermined amounts of M¹, M³, M⁴, an activating element, and, if necessary, M² (wherein each of M¹, M², M³, and M⁴ has the same meaning as described above) in an oxygen-containing atmosphere; and further firing a residue in an M⁵-containing atmosphere (wherein M⁵ has the same meaning as described above).

The mixed raw material can be obtained by weighing and mixing compounds containing the respective metal elements of M¹, M³, M⁴, an activating element, and, if necessary, M² so as to provide a predetermined composition (a composition capable of providing the phosphor of the present invention). As the compounds, compounds of the respective metal elements may be used, for example, in the form of oxides or in the form of nitrides, hydroxides, carbonates, nitrates, halides, oxalates, and the like. An adequate quantity of a halide such as a fluoride and a chloride can be used as the compound to control the crystallinity of the resulting phosphor and the average particle size of the particles constituting the phosphor. Here, the halide may also serve as a reaction accelerator (flux). Examples of the flux can include halides such as MgF₂, CaF₂, SrF₂, BaF₂, MgCl₂, CaCl₂, SrCl₂, BaCl₂, MgI₂, CaI₂, SrI₂, and BaI₂, ammonium salts such as NH₄Cl and NH₄I, and boron compounds such as B₂O₃ and H₃BO₃ and these compounds may be used as a compound constituting the mixed raw material or by adding adequate quantities of the compounds to the mixed raw material.

For example, a phosphor having a molar ratio of Sr:Eu:Mg:Sc:Si of 2.97:0.03:0.5:0.5:2 as one of the preferable phosphors in the present invention can be produced by weighing and mixing the raw materials of SrCO₃, Eu₂O₃, MgO, Sc₂O₃, and SiO₂ so as to provide a molar ratio of Sr:Eu:Mg:Sc:Si of 2.97:0.03:0.5:0.5:2, firing the resulting mixed raw material in an oxygen-containing atmosphere, and further firing a residue in an M⁵-containing atmosphere (wherein M⁵ has the same meaning as described above).

For the above mixing, an apparatus typically used industrially, such as a ball mill, a V-shaped mixer, and a stirrer, may be used. The mixing may also be carried out by wet mixing or dry drying. The mixed raw material may also be obtained through crystallization such as coprecipitation.

Depending on the composition, the above mixed raw material can be held, for example, in the temperature range of 600° C. or more to 1,600° C. or less in the time range of 0.3 hour more to 100 hours or less for firing to provide a phosphor of the present invention. The temperature at which the material is held during the firing is preferably from 1,100° C. or more to 1,400° C. or less.

Examples of the oxygen-containing atmosphere during firing can include an oxygen atmosphere and an air atmosphere. The M⁵-containing atmosphere is preferably an ammonia-containing atmosphere when M⁵ is N. Examples of the ammonia-containing atmosphere can include ammonia mixed atmospheres such as an ammonia-hydrogen mixed atmosphere and an ammonia-methane mixed atmosphere, in addition to an ammonia atmosphere. The concentration of ammonia in the mixed atmosphere can be adjusted to adjust the amount of N in the phosphor. The amount of N in the phosphor may also depend on the amount of M⁴. Also, for example, a high pressure nitrogen atmosphere such as an atmosphere of nitrogen of 0.1 atmospheric pressure or more may be used.

The mixed raw material may be provisionally fired by being held at a lower temperature than the temperature at which the material may also be held during the firing before the above firing to remove water of crystallization, followed by performing the firing. The atmosphere for provisional firing may be an oxygen-containing atmosphere, an inert gas atmosphere or a reducing atmosphere. The mixed raw material may also be pulverized after provisional firing. When the nitride is used in part or all of the mixed raw material, the mixed raw material can also be fired in an inert gas atmosphere or a reducing atmosphere to produce a phosphor of the present invention.

For the analysis of the composition of the phosphor of the present invention, the amount of M¹, M², M³, and M⁴ can be measured, for example, by emission spectrometry (an ICP analysis method) using a radio-frequency inductively coupled plasma as a light source. The amount of M⁵ can be measured, for example, when the mixed raw material is fired in an oxygen-containing atmosphere and further fired in an M⁵-containing atmosphere, from fluctuations in the weight thereof between after the firing in the oxygen-containing atmosphere and after the firing in the M⁵-containing atmosphere. This measurement may be carried out using a thermal analysis apparatus such as a TG-DTA measuring apparatus.

The phosphor obtained by the above method may be further pulverized using, for example, a ball mill, a jet mill, or the like. It may be also washed or sized. The pulverization and firing may also be performed two or more times. The surface of particles of the phosphor may also be subjected to surface treatment such as coating with a surface-modifying material. Examples of the surface-modifying material can include an inorganic substance containing Si, Al, Ti, La, Y, or the like.

The phosphor of the present invention obtained as described above can be used in light-emitting devices such as a white LED, backlight for liquid crystal display, a fluorescent lamp, a plasma display panel, a rare gas lamp, a CRT, a FED, an X-ray imaging device, and an inorganic EL display.

Particularly, the phosphor of the present invention can emit light by being excited by light having a wavelength of from 350 nm or more to 480 nm or less, preferably from 380 nm or more to 460 nm or less. Thus, the phosphor of the present invention can be used in a light-emitting device (a white LED) having the light-emitting element using a blue LED or a near-ultraviolet LED as a light-emitting element and a fluorescent material emitting light by being excited by at least part of light emitted by the light-emitting element, which light having the maximum luminescence intensity wavelength (λmax) in the range of 350 nm or more to 480 nm or less, preferably from 380 nm or more to 460 nm or less, in a wavelength-luminescence intensity curve within the wavelength range of 300 nm or more to 780 nm or less. Here, the fluorescent material needs only to at least contain the phosphor of the present invention, and may also further contain another phosphor as described later.

The light-emitting element used in the light-emitting device will now be specifically described, taking a blue LED or a near-ultraviolet LED as an example. The blue LED or near-ultraviolet LED can be produced using a well-known technique as disclosed, for example, in JP 06-177423 A or JP 11-191638 A. Specifically, these LEDs each have a structure in which an n-type compound semiconductor layer (n-type layer), a light-emitting layer comprising a compound semiconductor (light-emitting layer), and a p-type compound semiconductor layer (p-type layer) are laminated on a substrate. Examples of the substrate include sapphire, SiC, and Si. Methods for laminating the compound semiconductor layers include commonly used MOVPE (Metal Organic Vapor Phase Epitaxy) and MBE (Molecular Beam Epitaxy) methods. The elemental composition of the light-emitting layer compound semiconductor used is GaN, InᵢGa₁₋ᵢN(0<i<1), InᵢAlⱼGa₁₋ᵢ₋ⱼN(0<i<1, 0<j<1, i+j<1), or the like. The composition can be altered to shift the wavelength of emitted light, that is, the wavelength of near-ultraviolet light to blue-violet light or blue light. The amount of impurities contained in the light-emitting layer is preferably kept at a low level. Specifically, when Si, Ge, and group-II elements are used as impurities, each concentration thereof is preferably 10¹⁷ cm⁻³ or less. The light-emitting layer may have a single quantum well structure or a multiquantum well structure. The thickness of the light-emitting layer is preferably from 5 Å or more to 300 Å or less, more preferably from 10 Å or more to 90 Å or less. A thickness of less than 5 Å or more than 300 Å may make the luminance efficiency insufficient.

As the p-type and n-type layers, compound semiconductors are used which have larger band gaps than the band gap of the compound semiconductor in the light-emitting layer. The light-emitting layer can be disposed between the n-type layer and p-type layer to provide a light-emitting element. Some layers different in the composition, conductivity and doping concentration may be inserted as needed between the n-type layer and the light-emitting layer and between the light-emitting layer and the p-type layer. Examples of the elemental composition of the compound semiconductor of the inserted layer include the above-described InᵢAlⱼGa₁₋ᵢ₋ⱼN(0<i<1, 0<j<1, i+j<1); among these, used are compositions which are different in the composition, conductivity, doping concentration, and the like from that of the light-emitting layer.

The two layers adjacent to the light-emitting layer are called charge injection layers. When the above inserted layers are present, the inserted layers represent charge injection layers, and when the inserted layers are absent, the n-type layer and the p-type layer represent charge injection layers.

Positive and negative charges are injected from the two charge injection layers into the light-emitting layer; the charges recombine to emit light. In order to efficiently recombine the charges injected into the light-emitting layer to provide light of high intensity, a light-emitting element is preferably made which has a structure in which inserted layers having larger band gaps than that of the light-emitting layer are inserted between the n-type layer and the light-emitting layer and between the light-emitting layer and the p-type layer to make charge injection layers (the so-called double heterostructure).

The difference in the band gap between each charge injection layer and the light-emitting layer is preferably 0.1 eV or more. A difference in the band gap between each charge injection layer and the light-emitting layer of less than 0.1 eV may reduce the luminance efficiency of the light-emitting element because it makes the confinement of carriers insufficient. The difference in the band gap is more preferably 0.3 eV or more. However, a band gap of the charge injection layer of more than 5 eV increases the voltage necessary for charge injection; thus, the band gap of the charge injection layer is preferably 5 eV or less. The thickness of the charge injection layer is preferably from 10 Å or more to 5,000 Å or less. A thickness of the charge injection layer of less than 5 Å or more than 5,000 Å tends to reduce the luminance efficiency of the light-emitting element. The thickness of the charge injection layer is more preferably from 10 Å or more to 2,000 Å or less.

The light-emitting element obtained as described above emits light having the maximum luminescence intensity wavelength (λmax) in the range of 350 nm or more to 480 nm or less, in a wavelength-luminescence intensity curve within a wavelength range of 300 nm or more to 780 nm or less. Here, the wavelength-luminescence intensity curve is a curve in which light is shown by plotting the luminescence intensity against the wavelength, and also sometimes referred to as a luminescence emission spectrum. The wavelength-luminescence intensity curve can be obtained using a fluorescence spectrophotometer.

A method for producing the light-emitting device having the above light-emitting element and a fluorescent material emitting light by being excited by at least part of the light emitted by the light-emitting element will now be described, taking a white LED as an example. As a method for producing the white LED, well-known methods as disclosed, for example, in JP 05-152609 A and JP 07-99345 A can be used. Specifically, a fluorescent material can be dispersed in a translucent resin such as epoxy resin, polycarbonate, and silicon rubber, followed by molding the fluorescent material-dispersed resin so as to surround a blue LED or a near-ultraviolet LED to produce a white LED. The white LED can also be produced without dispersing the fluorescent material in the translucent resin. Specifically, the translucent resin (wherein the translucent resin contains no phosphor) may also be molded so that it may surround a blue LED or a near-ultraviolet LED, followed by forming a fluorescent material layer on the surface thereof to produce a white LED. At this time, the surface of the fluorescent material layer may also be further covered with the translucent resin.

In producing the white LED, the composition and amount of the fluorescent material are properly set so that a desired white light may be emitted. As the fluorescent material, the phosphor of the present invention may also be used alone or in combination with another phosphor. Examples of another phosphor include BaMgAl₁₀O₁₇:Eu, (Ba, Sr, Ca)(Al, Ga)₂S₄:Eu, BaMgAl₁₀O₁₇:Eu, Mn, BaAl₁₂O₁₉:Eu, Mn, (Ba, Sr, Ca)S:Eu, Mn, Y₃Al₅O₁₂:Ce, (Y, Gd)₃Al₅O₁₂:Ce, YBO₃:Ce, Tb, Y₂O₃:Eu, Y₂O₂S:Eu, YVO₄:Eu, (Ca, Sr)S:Eu, SrY₂O₄:Eu, Ca—Al—Si—O—N:Eu, and Li—(Ca, Mg)-Ln-Al—O—N:Eu (wherein Ln represents a rare earth metal element other than Eu).

### EXAMPLES

The present invention will now be described in further detail with reference to an Example. However, the present invention is not limited to the Example.

The light-emitting characteristics of a phosphor were evaluated by measuring an excitation spectrum and a luminescence emission spectrum in the air, using a spectrophotofluorometer (FP6500 from JASCO Corporation).

The powder X-ray diffraction pattern of the phosphor was measured by powder X-ray diffractometry using a characteristic X-ray of CuKα. The X-ray diffraction-measuring apparatus Model RINT2500TTR from Rigaku Corporation was used as a measuring apparatus.

### Comparative Example 1

The raw materials of barium carbonate, europium oxide, scandium oxide, and silicon dioxide were weighed so as to provide a molar ratio of Ba:Eu:Sc:Si of 8.55:0.45:2:6 and mixed with a wet ball mill using acetone for 4 hours to provide a slurry.

After drying the resulting slurry using an evaporator, the resulting mixed raw material was held at a temperature of 1,300° C. in an atmosphere of the air for 6 hours for firing and then slowly cooled to room temperature. Subsequently, the material was pulverized with an agate mortar, held at a temperature of 1,300° C. in an atmosphere of Ar containing 5% by volume of H₂ for 6 hours for firing, and then slowly cooled to room temperature to provide phosphor 1 consisting of a compound represented by the formula (Ba_{0.95}Eu_{0.05})₉Sc₂Si₆O₂₄.

When the light-emitting characteristics (an excitation spectrum and a luminescence emission spectrum) of the phosphor 1 were evaluated, it was found that the phosphor 1 was excited by light having a wavelength of from 350 nm or more to 480 nm or less to emit light having the maximum luminescence intensity at a wavelength of 510 nm.

### Example 1

The same mixed raw material as in Comparative Example 1 was held at a temperature of 1,300° C. in an atmosphere of the air for 6 hours for firing and then slowly cooled to room temperature. Subsequently, the material was pulverized with an agate mortar, held at a temperature of 1,300° C. in an ammonia atmosphere for 6 hours for firing, and then slowly cooled to room temperature. After that, the material was pulverized with an agate mortar, again held at a temperature of 1,300° C. in an ammonia atmosphere for 6 hours for firing, and then slowly cooled to room temperature to provide phosphor 2 consisting of a compound represented by the formula (Ba_{0.95}Eu_{0.05})₉Sc₂Si₆O₂₁N₂.

According to the excitation spectrum and luminescence emission spectrum of the phosphor 2, it was found that the phosphor obtained in Example 1 was excited by light having a wavelength of from 350 nm or more to 480 nm or less to emit light having the maximum luminescence intensity at a wavelength of 570 nm.

As described above, the use of the phosphor of the present invention in a light-emitting device is shown to make a phosphor capable of providing a light-emitting device which can also lengthen the wavelength of emitted light and further improve light-emitting characteristics such as color rendering properties.

1. A phosphor comprising a compound represented by a formula (1):
aM¹O.3M²O.6M³O₂ (1)
(wherein M¹ represents one or more alkaline earth metal elements selected from the group consisting of Ba, Sr, and Ca; M² represents one or more divalent metal elements selected from the group consisting of Mg and Zn; M³ represents a tetravalent metal element; and a represents a value in the range of 3 or more to 9 or less),
at least part of M² in the compound being substituted with M⁴ (wherein M⁴ represents a trivalent cation element),
part of O in the compound being substituted with M⁵ (wherein M⁵ represents a trivalent anion element), and
part of M¹ and/or M² in the compound being substituted with an activating element.

2. The phosphor according to claim 1, wherein the value of a is 9.

3. A phosphor comprising a compound represented by a formula (2):
M¹₉(M²_{3-1.5x}M⁴ₓ)M³₆O_{24-1.5y}M⁵_{y} (2)
(wherein each of M¹, M², M³, M⁴, and M⁵ has the same meaning as described above; x represents a value in the range of more than 0 to 2 or less; and y represents a value in the range of more than 0 to 2 or less),
part of M¹ and/or M² being substituted with an activating element.

4. The phosphor according to claim 2, having the same type of crystal structure as that of merwinite.

5. The phosphor according to claim 1, wherein M³ is Si.

6. The phosphor according to claim 1, wherein M⁴ is Sc.

7. The phosphor according to claim 1, wherein M⁵ is N.

8. The phosphor according to claim 1, wherein part of M¹ in the compound is substituted with an activating element.

9. The phosphor according to claim 1, wherein the activating element is Eu.

10. A method of producing a phosphor, comprising the steps of: firing a mixed raw material containing predetermined amounts of M¹, M³, M⁴, an activating element, and, if necessary, M² (wherein each of M¹, M², M³, and M⁴ has the same meaning as described above) in an oxygen-containing atmosphere; and further firing a residue in an M⁵-containing atmosphere (wherein M⁵ has the same meaning as described above).

11. The production method according to claim 10, wherein the M⁵-containing atmosphere is an ammonia-containing atmosphere.

12. A light-emitting device comprising the phosphor according to claim 1.

13. A light-emitting device comprising a light-emitting element and a fluorescent material emitting light by being excited by at least part of the light emitted by the light-emitting element, wherein the fluorescent material comprises the phosphor according to claim 1.

14. The light-emitting device according to claim 13, wherein the light emitted by the light-emitting element is light having the maximum luminescence intensity wavelength (λmax) in the range of 350 nm or more to 480 nm or less, in a wavelength-luminescence intensity curve using the wavelength range of 300 nm or more to 780 nm or less.
